(19) United States
(12) Patent Application Publication
(10) Pub. No.: US 2024/0135838 A1
(43) Pub. Date: Apr. 25, 2024

(54) ANATOMICAL HEAD AND NECK SIMULATOR APPARATUS

(71) Applicant: HALO MED LLC, Scarborough, ME (US)

(72) Inventor: Jason F. Hine, Scarborough, ME (US)

(73) Assignee: HALO MED LLC, Scarborough, ME (US)

(21) Appl. No.: 18/547,463

(22) PCT Filed: Feb. 22, 2022
(86) PCT No.: PCT/US2022/017254

§ 371 Date: Aug. 21, 2023

(51) Int. Cl. G09B 23/30

(52) U.S. Cl. CPC G09B 23/30

(57) ABSTRACT

A simulator apparatus for training medical professionals in various procedures involving the head, eye, larynx, and esophagus. The apparatus includes a head and neck model, an eye model, a cricothyroid model, and an esophagus model. The head and neck model is designed to be removably attached to the eye model, cricothyroid model, and esophagus model. The head and neck model simulates the human head, the eye model simulates the human eye, the cricothyroid model simulates the human larynx thyroid, and cricothyroid cartilage, and the esophagus model simulates the human esophagus. For training purposes, the models may be used individually without accompaniment of the other models, or in conjunction with one or more of the other models. The purpose of the simulator is to provide a user with a cost-effective, portable training simulator to practice performing procedures involving the human head, eye, larynx and cricothyroid muscle, and esophagus.

### BACKGROUND OF THE INVENTION

### 1. Field of the Invention

The present invention relates to the training of medical professionals in emergency medicine and lifesaving procedures. More particularly, the present invention relates to medical procedure simulation models. Still more particularly, the present invention relates to a simulator apparatus designed to simulate an anatomical head and neck of a human.

### 2. Description of the Prior Art

Emergency medicine and other specialties are responsible for performing several lifesaving procedures. Many of these procedures are rare, limiting the amount of skill maintenance that can be done with patient care. Procedural skill proficiency and competence can be maintained through simulation, but most active practicing clinicians do not have ready access to a simulation center. The training of medical professionals requires access to easy-to-use simulators which allow procedural skillset maintenance, as well as the training of medical students, residents, and other learners.

Many current trainers are complex, expensive, and are, therefore, only available to learners/practitioners who have access to a simulation center. Most currently practicing clinicians do not have ready access to a simulation center, must pay significant costs for the use of simulation center space and resources, and/or do not, given the above noted obstacles, utilize such facilities for a variety of reasons. The cost and limited spectrum of use of current simulators prohibits the average practicing clinician from accessing them, at least with a frequency to allow for skill maintenance. This leads to procedural skill set decay, especially in uncommon and infrequent procedures. Access to trainers at practitioner's homes or place of practice would help eliminate many of these barriers to procedural training, and therefore, procedural skill maintenance.

A need, therefore, exists for low- to mid-fidelity simulators that can be utilized outside of a simulation center. In particular, practitioners would benefit from easy assembled, simple to use simulators that maintain the necessary fidelity to practice procedures, particularly ones that are rarely seen in clinical practice. Trainers or simulators that are deliverable to the end users' homes or places of practice would help eliminate many of these barriers to procedural training.

The present invention solves the above noted problems by creating a low-cost medical simulator that facilitates the practice of several different medical procedures, including lateral canthotomy, cricothyrotomy, and esophagogastric balloon placement. The inventive model may also be used to practice other procedures associated with head, thyroid, cricothyroid, and eye anatomy, such as orogastric tube insertion.

### SUMMARY OF THE INVENTION

The current invention provides a solution to the need for a simulator that aids in training users to carry out medical procedures. The invention is a medical procedure training simulator apparatus that facilitates the practice of procedures in the head and neck area. The simulator is in the form of an easy-to-ship product that can be utilized anywhere. Prior to this invention, the ability to practice these procedures in situ (where they practice medicine, an ideal location for training) or in the home environment, was not feasible to the training or practicing clinician due to lack of access, expense of materials or a combination of the above.

The anatomical head and neck simulator may be used to practice a variety of procedures including but not limited to lateral canthotomy, cricothyrotomy, esophagogastric balloon placement, and other procedures associated with the head, thyroid/cricothyroid, esophagus, trachea, and eye anatomy. The present invention provides a method in which the user may utilize the simulator to train on specific models separate from the other models listed herein. Alternatively, the user may choose to utilize the simulator with all models attached to better simulate real-life conditions.

In an embodiment, the simulator is a structure formed to represent the human neck and head. The simulator contains an assembly comprising a human head and neck model, a cricothyroid model, an eye model, and an esophagus model. One or more of those components may be optional, and/or individual assemblies may include a single component or a subset of these components. The cricothyroid model fits into the neck portion of the head and neck model. The eye model fits into a cylindrical cut out in one of the eye portions of the head and neck model. The esophagus model is removably connected to the neck portion of the head and neck model to form a tube-like structure connecting from the mouth of the head and neck model through to the esophagus model and esophagus extension, simulating that of the human esophagus.

The head and neck model may serve as the base to which the cricothyroid model, eye model, and esophagus model are removably attached. The head and neck model is designed to receive the designated models. The cricothyroid model may be removably attached to the head and neck model in a designated area located in the neck portion of the head and neck model. The one or two eye models may be removably attached to the head and neck model in the designated cylindrical eye cut outs. The esophagus model may be removably inserted to the head and neck model in a designated area located inside the neck the portion of the head and neck model.

The head and neck model is shaped to simulate that of the human head to provide an accurate simulation of the procedures when in use. The size of the head and neck model is designed to be of a similar size to that of an average human head. When in use, the head and neck model may be placed on a flat surface to utilize optional suction cups. Alternatively, the head and neck model may be placed on a surface at an angle to simulate various conditions. In an embodiment, the head and neck model may be adhered to a flat surface using the optional suction cups located on the back side of the head and neck model.

The cricothyroid model may be removably attached to the head and neck model in an area of the neck portion of the head and neck model. The cricothyroid model is designed to simulate the human larynx. The cricothyroid model may be used as a standalone model for training procedures involving the larynx. The model may be placed on a flat surface and utilized without the head and neck model, eye model, and esophagus model. Alternatively, the model may be used in conjunction with the head and neck model, eye model, and esophagus model to better simulate real conditions.

The eye model may be removably attached to the head and neck model in the cylindrical cut out of the head and neck model. The eye model is designed to simulate the human eye. The head and neck model may be configured to have one or two cylindrical cut outs to receive the one or two eye models. The eye model may be used as a standalone model for training procedures involving the eye such as lateral canthotomy. The model may be placed on a flat surface, adhered with suction cups inserted into the back end, and utilized without the head and neck model, cricothyroid model, and esophagus model. Alternatively, the model may be used in conjunction with the head and neck model, cricothyroid model, and esophagus model to better simulate real conditions.

The esophagus model may be removably inserted inside the neck portion of the head and neck model. The esophagus model is designed to simulate the human esophagus. The removable esophagus model is comprised of the mouth opening, esophagus, and esophagus extension. The esophagus model may be used as a standalone model for training procedures involving the esophagus. The model may be placed on a surface and utilized without the head and neck model, eye model, or cricothyroid model. Alternatively, the model may be used in conjunction with the head and neck model, cricothyroid model, and eye model to better simulate real conditions.

The head and neck model is equipped to engage with each of the cricothyroid model, eye model(s), and esophagus model uniquely. The head and neck model is designed to receive the cricothyroid model in a rectangular cut out in the neck of the head and neck model to simulate where a human larynx would be located. The cylindrical shape designed to receive the eye model is configured to receive the eye model and stabilize the eye model such that the conditions would simulate a user performing a procedure on an actual human eye. The esophagus model is inserted inside the neck portion of the head and neck model to simulate that of the human esophagus. The head and neck model has an opening in the mouth which traverses through and within the esophagus within the head and neck model to an opening at the neck portion of the head and neck model. The esophagus model is inserted into to the head and neck model. The esophagus extension is connected to the esophagus at the opening at the neck portion of the head and neck model. The opening from the mouth of the head and neck model to the esophagus model is designed to simulate that of a human mouth, throat, and esophagus. The simulator may have a flat back, suction cups, or other optional supplemental features allowing the simulator to rest flat or be removably attached to a surface to allow for use of the simulator.

In another embodiment, the simulator is a structure formed of the head and neck model, cricothyroid model, eye model, and esophagus model as one solid structure wherein each individual model is built into the simulator. In yet another embodiment, the simulator is formed with one or more of the models described herein.

It is an object of the simulator to be easily portable such that the user may move the simulator or models of the simulator in an easy and convenient way to enable training in almost any location.

### BRIEF DESCRIPTION OF THE DRAWINGS

FIG. 1 is a front elevation view of the head and neck model of the present invention.

FIG. 2 is a left side elevation view of the head and neck model.

FIG. 3 is a right side elevation view of the head and neck model.

FIG. 4 is a bottom plan view of the head and neck model.

FIG. 5 is a top plan view of the head and neck model.

FIG. 6 is a rear elevation view of the head and neck model of FIG. 1 showing the esophagus model of FIG. 19.

FIG. 7 is a front elevation view of the training simulator comprising the head and neck model of FIG. 1, the cricothyroid model of FIG. 6, the eye model of FIG. 11, and the esophagus model of FIG. 19.

FIG. 8 is a front elevation view of the cricothyroid model of the present invention.

FIG. 9 is a left side elevation view of the cricothyroid model.

FIG. 10 is a right side elevation view of the cricothyroid model.

FIG. 11 is a bottom plan view of the cricothyroid model.

FIG. 12 is a top plan view of the cricothyroid model.

FIG. 13 is a front elevation view of the eye model of the present invention.

FIG. 14 is a side perspective view of the eye model.

FIG. 15 is a rear elevation view of the eye model.

FIG. 16 is a front elevation view of the esophagus extension.

FIG. 17 is a bottom perspective view of the esophagus extension.

FIG. 18 is a top perspective view of the esophagus extension.

FIG. 19 is a front elevation view of the esophagus model with the esophagus extension.

FIG. 20 is a side elevation view of the esophagus model with the esophagus extension.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

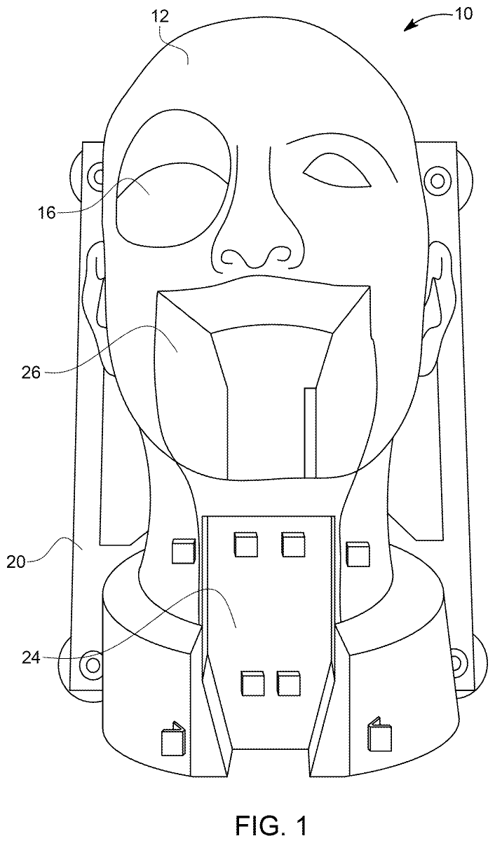

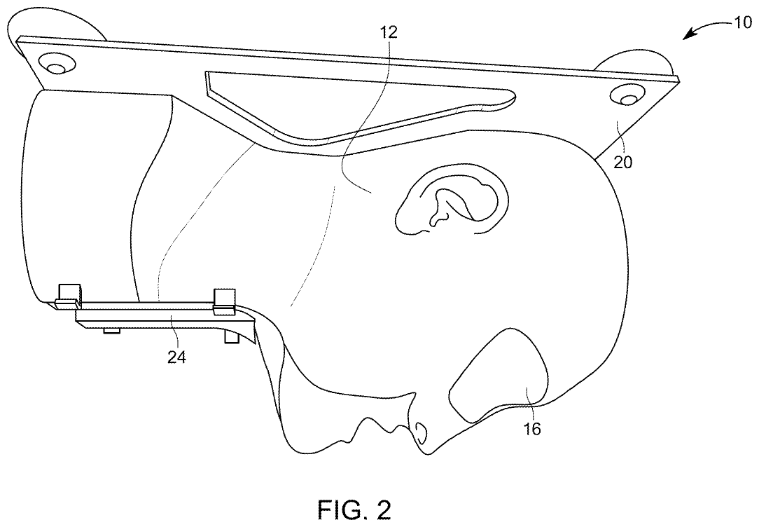

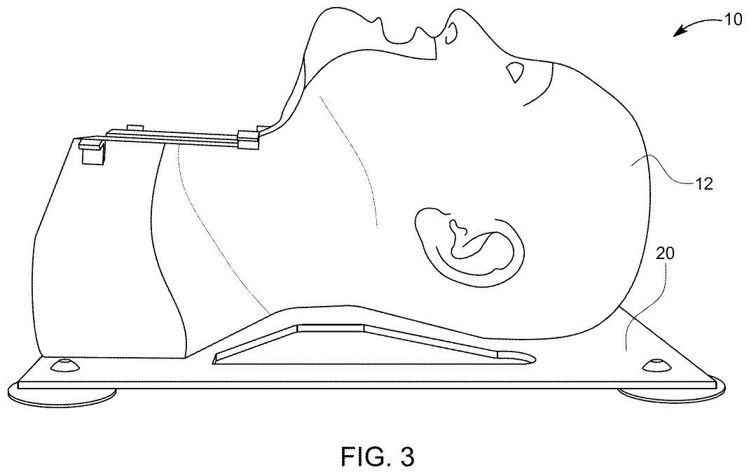

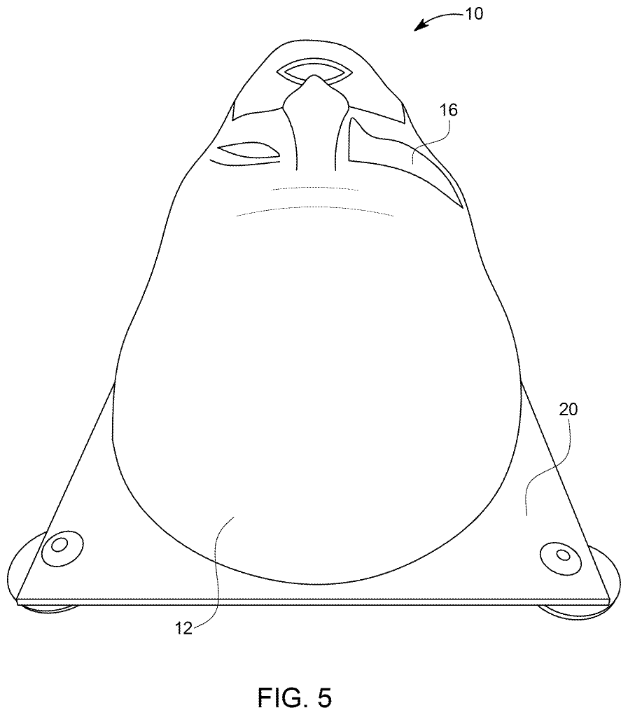

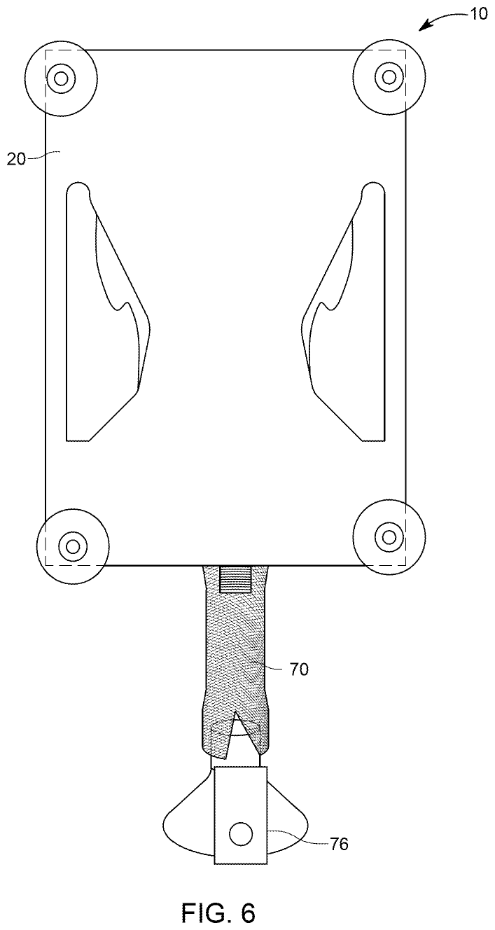

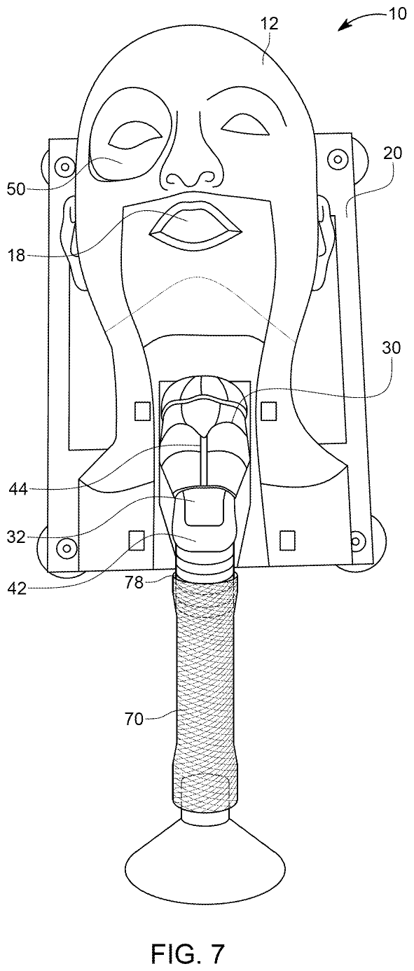

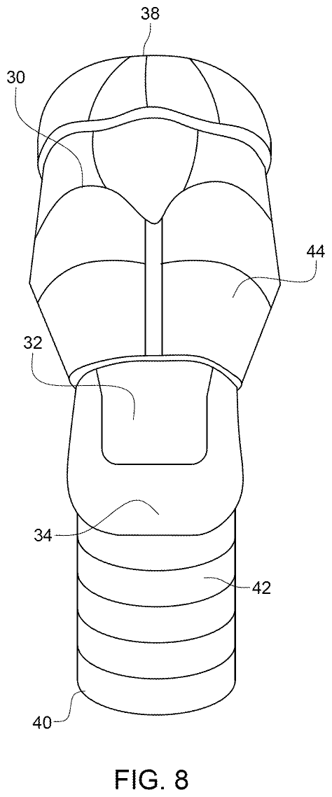

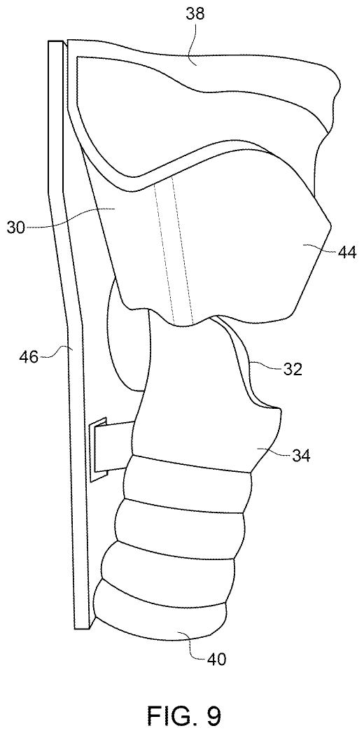

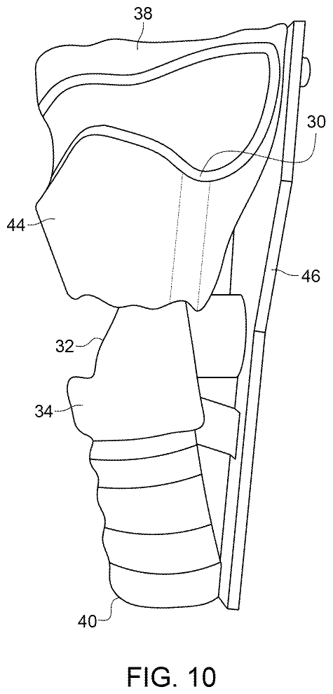

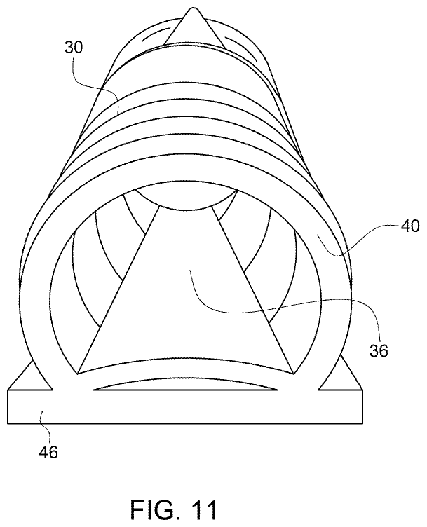

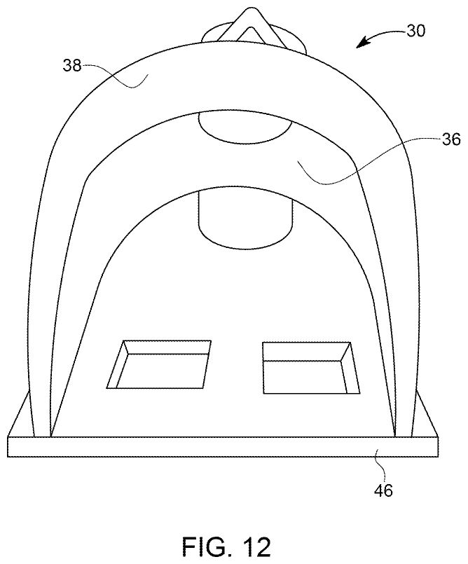

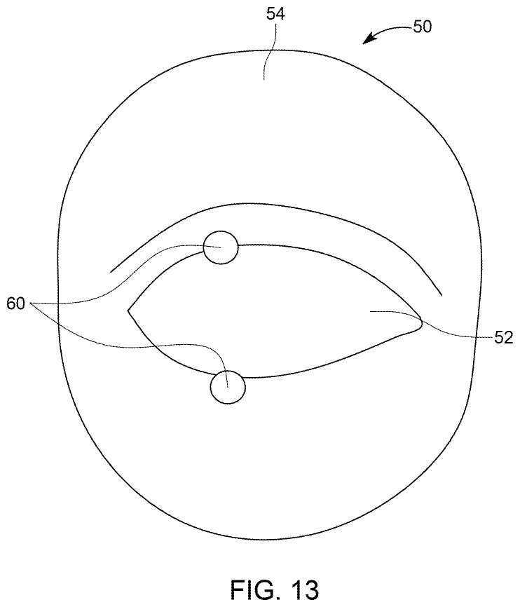

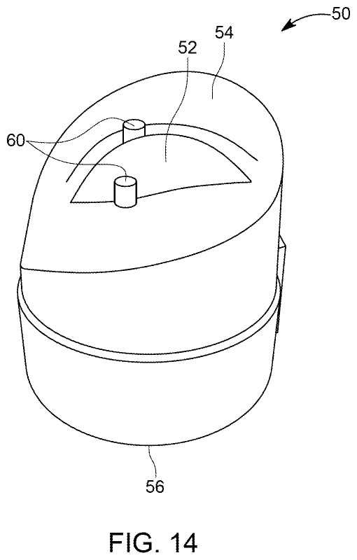

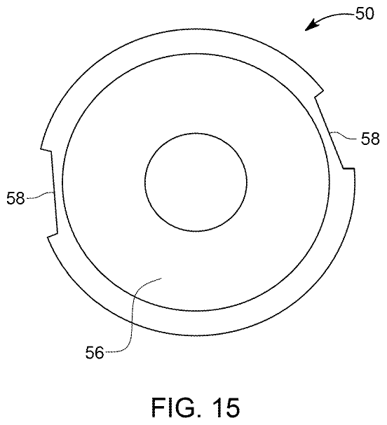

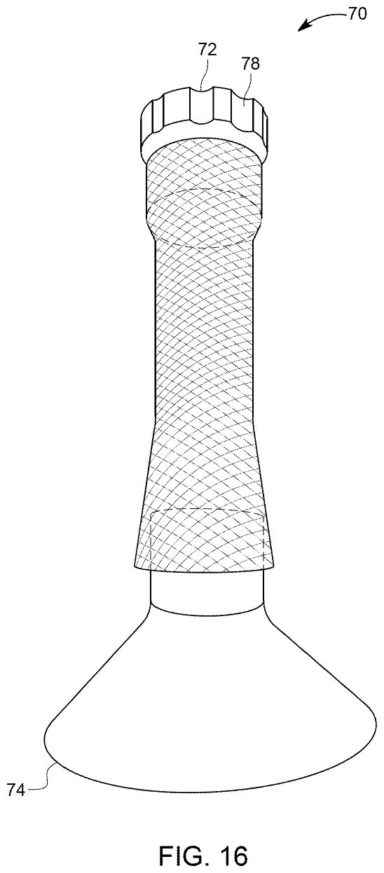

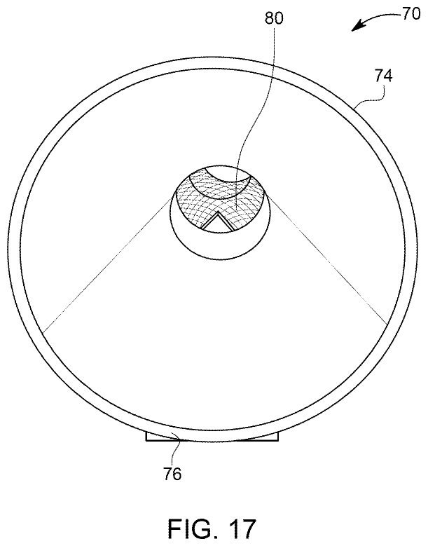

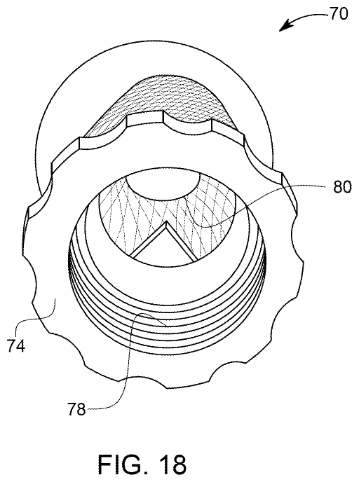

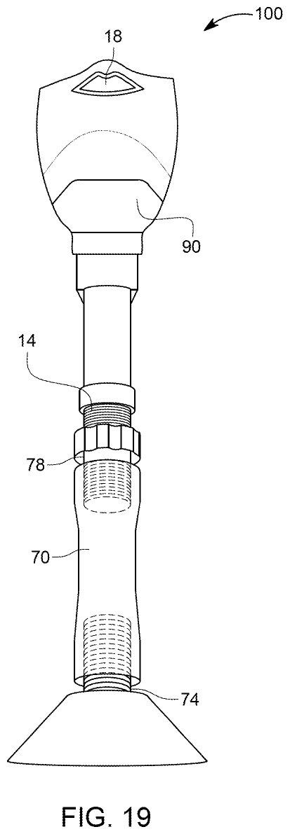

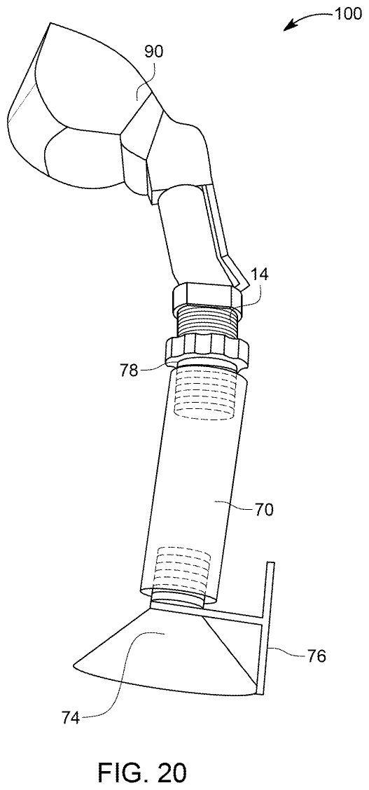

An anatomical head and neck simulator apparatus 10 of the present invention is shown in FIGS. 1-20. The simulator apparatus 10 includes a head and neck model 12, a cricothyroid model 30, an eye model 50, and an esophagus model 100 and an esophagus extension 70. The head and neck model 12 is shown alone in FIGS. 1-5. The simulator apparatus 10 comprising the head and neck model 12, cricothyroid model 30, eye model 50, and esophagus model 100 is shown in FIGS. 6 and 7. The cricothyroid model 30 is shown alone in FIGS. 8-12. The eye model 50 is shown alone in FIGS. 13-15. The esophagus extension 70 is shown alone in FIGS. 16-18. The esophagus model 100 and the esophagus extension 70 are shown in FIGS. 19-20.

The present invention may be used to facilitate training and practicing of a number of medical procedures involving the head and neck. The procedures include, but are not limited to, esophagogastric balloon insertion, cricothyrotomy, and lateral canthotomy. Esophagogastric balloon insertion is the insertion of a balloon into the esophagus and gastric area of a patient as a means of tamponading bleeding. Cricothyrotomy is the placement of a breathing tube through the cricothyroid membrane. A lateral canthotomy is the cutting of ocular ligaments to relieve intraocular pressure.

The head and neck model 12 is designed to simulate that of the human head and neck. The head and neck model 12 has a cylindrical cut out 16, a base 20, a rectangular cut out 24, and a mouth cut out 26 The head and neck model 12 is configured to receive the eye model 50, cricothyroid model 30, and esophagus model 100. The cylindrical cut out 16 of the head and neck model 12 is configured to receive the eye model 50. The rectangular cut out 24 of the head and neck model 12 is configured to receive the cricothyroid model 30. The mouth cut out 26 of the head and neck model 12 is configured to receive the esophagus model 100. The esophagus model 100 is configured to receive the esophagus extension 70. The head and neck model 12 may be used in conjunction with one or more of the cricothyroid model 30, eye model 50, the esophagus model 100, and the esophagus extension 70. Additionally, the cricothyroid model 30, the eye model 50, and the esophagus model 100 with or without the esophagus extension 70 may each be used separately. The simulator apparatus 10 is configured to be used as a medical procedures teaching device, allowing the use to perform procedures which generally involve the head and neck area. More specifically, the apparatus 10 has the cricothyroid model 30, eye model 50, esophagus model 100 and esophagus extension 70 to teach procedures involving the human cricothyroid, eye, and esophagus. The base 20 of the head and neck model 12 is configured to allow the head and neck model 12 be placed on a surface to allow the apparatus 10 to be used.

The head and neck model 12 is shown in FIGS. 1-6. The head and neck model 12 has a cylindrical cut out 16 which is configured to receive the eye model 50. The mouth cut out 26 of the head and neck model 12 is configured to receive the esophagus model 100. The rectangular cut out 24 of the head and neck model 12 is configured to receive the cricothyroid model 30. The base 20 of the head and neck model 12 is configured to be placed on a surface, providing stability when the apparatus 10 is in use. The base 20 may be configured with methods to secure the apparatus 10 to the working surface or may be configured to rest on the working surface.

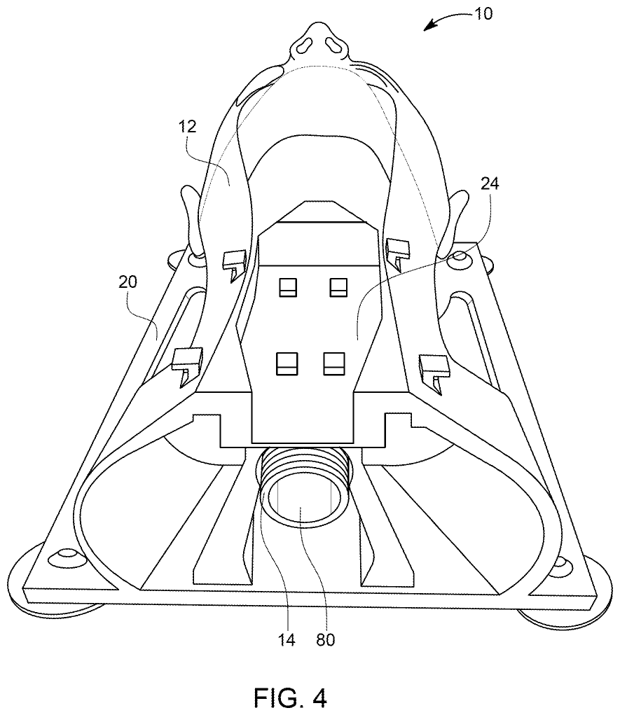

FIG. 4 depicts the bottom plan view of the head and neck model 12 with the esophagus model 100 inserted. The esophagus model 100 has a passage 80 and an esophagus extension attachment site 14. The attachment site 14 of the esophagus model 100 may be threaded or utilize another method of connection in which the esophagus extension 70 may be removably connected to the esophagus model 100.

FIGS. 6 and 7 depict the apparatus 10 with the eye model 50, cricothyroid model 30, esophagus model 100, and the esophagus attachment 70 all engaged with the head and neck model 12. The eye base 56 is removably engaged with the cylindrical cut out 16, which alternatively can receive a suction cup and allow the eye model 50 to be secured to a flat surface. The cricothyroid base 46 is removably engaged with the rectangular cut out 24. The esophagus model 100 is removably engaged with the mouth cut out 26. The esophagus extension attachment 78 is removably engaged with the esophagus extension attachment site 14. The apparatus 10 may be used in conjunction with one or more of the head and neck model 12, the eye model 50, the cricothyroid model 30, the esophagus model 100, and the esophagus extension 70. To add fidelity to the training, the eye model 50, the cricothyroid model 30, the esophagus model 100, and esophagus extension 70 may all be engaged with the head and neck model 12 to depict the human anatomy. In FIG. 7, it may appear as though the esophagus extension 70 is connected to the cricothyroid model 30; however, the esophagus extension 70 is connected to the esophagus extension attachment site 14 of the esophagus model 100, located beneath the cricothyroid model 30. The esophagus extension attachment site 14 is depicted in FIG. 4 beneath the rectangular cut out 24 in which the cricothyroid model 30 is removably engaged.

The cricothyroid model 30 shown in FIGS. 8-12 has a procedure site 32, a cricoid cartilage 34, an airway 36, a cricothyroid top end 38, a cricothyroid bottom end 40, a trachea 42, a thyroid cartilage 44, and a cricothyroid base 46. The cricothyroid model 30 is designed to simulate that of the human cricothyroid muscle, thyroid, and trachea. The thyroid cartilage 44, thyroid protrusion 34, trachea 42, and procedure site 32 are configured to mirror that of the human anatomy, allowing the user to practice procedures at the procedure site 32 in conditions to simulate an actual procedure. The cricothyroid base 46 is configured to be placed on a surface while in use. The cricothyroid base 46 may also be configured to be removably engaged with the rectangular cut out 24 of the head and neck model 12. The cricothyroid model 30 may be used individually or in conjunction with the head and neck model 12. The cricothyroid base 46 may be configured to be removably engaged with the rectangular cut out 24 of the head and neck model 12 with pegs, clips, or other such methods to hold the cricothyroid model 30 in place while in use. Subcutaneous fat and skin can be created using off the shelf materials such as foam and silicone sheeting, which can be laid over the cricothyroid model 30 and adhered to the head and neck model 12 with pegs, clips, or other such adhesion methods. Additionally, the cricothyroid base 46 may be configured to be placed on a surface providing stability when the cricothyroid model 30 is in use.

As shown in FIGS. 8-12, the airway 36 of the cricothyroid model 30 traverses from the cricothyroid top end 38 through the cricothyroid bottom end 40 to simulate that of the human airway. The cricoid cartilage 34, the thyroid cartilage 44, and the trachea 42 of the cricothyroid model 30 simulate that of the human thyroid cartilage, cricothyroid cartilage, and trachea. The procedure site 32 of the cricothyroid model 30 may be used to practice the insertion of a breathing tube through the cricothyroid membrane.

Cricothyrotomy, or placement of a breathing tube through the cricothyroid membrane, may be practiced directly on the cricothyroid model 30 shown in FIGS. 8-12. To add to the fidelity of the training, the cricothyroid model 30 may be placed in the rectangular cut out 24 of the head and neck model 12. The cricoid cartilage 34, the thyroid cartilage 44, and the trachea 42 provide an anatomical structure to simulate that of the human cricothyroid. The cricothyrotomy procedure may be performed on the procedure site 32 of the cricothyroid model 30. The cricothyroid model 30 may be used in conjunction with the head and neck model 12 or on a standalone basis. Other commercially available or off the shelf material may be applied over the entire unit to simulate the cricothyroid membrane, subcutaneous tissue, and skin on the model.

The eye model 50 shown in FIGS. 13-15 has an eyeball 52, an eye inset 54, and an eye base 56, one or more eye base channels 58, and may optionally have one or more eye pegs 60. The eye model 50 is designed to simulate that of the human eye and surrounding environment. The eyeball 52 may be used to perform procedures involving the eye. The eye inset 54 provides structure to hold the eyeball 52 in place while in use. The eye inset 54 may be used to practice procedures involving the area surrounding the eye. The eye base 56 is configured to be placed on a surface while in use. The eye base 56 is also be configured to be removably engaged with the cylindrical cut out 16 of the head and neck model 12. The eye model 50 may be used individually or in conjunction with the head and neck model 12. The eye base 56 may be configured to be removably engaged with the cylindrical cut out 16 of the head and neck model 12 with pegs, clips, or other such methods to hold the eye model 50 in place while in use. The one or more eye base channels 58 are configured to allow for rubber bands or other off the shelf material to be attached to the eye model 50. The one or more optional eye pegs 60 are configured to align the rubber bands or other off the shelf material to simulate the alignment of human eye ligaments.

Lateral canthotomy, or cutting of ocular ligaments to relieve intraocular pressure, may be practiced directly on the eye model 50 shown in FIGS. 13-15. To add to the fidelity of the training, the eye model 50 may be placed in the cylindrical cut out 16 of the head and neck model 12. The eyeball 52 is made of a material suitable for practicing the procedure on the eyeball 52 of the eye model 50. The eye inset 54 of the eye model 50 may be used to practice procedures involving the surrounding area of the eyeball 52. Additionally, the eye inset 54 provides support of the eyeball 52 and anatomical simulation of the area around the eye. In this configuration, the one or more eye based channels 58 are designed to receive rubber bands or off the shelf material to replicate anatomical ligaments that need to be cut during the lateral canthotomy procedure. The one or more eye pegs 60 are designed to engage and hold in place the materials used as eye ligaments to mirror that of the human eye ligaments. The eye model 50 may be used in conjunction with the head and neck model 12 or on a standalone basis. Practitioners may apply commercially available materials to the eye model 50 to replicate the upper and lower eyelids with associated ligaments.

The esophagus extension 70 shown in FIGS. 16-18 has an esophagus extension top end 72, an esophagus extension bottom end 74, an esophagus extension base 76, an esophagus extension attachment 78, and a passage 80. The esophagus extension 70 is designed to simulate that of the lower portion of the human esophagus. The esophagus extension attachment 78 is configured to be removably engaged with the esophagus extension attachment site 14 of the esophagus model 100. The esophagus extension base 76 is configured to rest on or be removably engaged with a surface. The esophagus extension 70 may be used in conjunction with the esophagus model 100.

The esophagus model 100 shown in FIGS. 19-20 has a mouth opening 18, an esophagus 90, and an esophagus extension attachment site 14, and the passage 80. The esophagus model 100 is configured to be removably engaged with the mouth cut out 26 of the head and neck model 12. The passage 80 of the esophagus model 100 initiates at the mouth opening 18 of the esophagus model 100 and traverses through the esophagus extension attachment site 14. The esophagus extension 70 is removably attached to the esophagus extension attachment site 14 with the esophagus extension attachment 78. The mouth opening 18 of the esophagus model 100 facilitates the insertion of an esophagogastric balloon or orogastric tube into the passage 80.

As shown in FIGS. 16-20, the esophagus model 100 has a passage 80 which traverses from the mouth opening 18, through the esophagus 90, the esophagus attachment site 14 and the esophagus extension 70. The passage 80 extends from the esophagus extension top end 72 through the esophagus extension bottom end 74. The passage 80 for the tube insertion during the esophagogastric balloon insertion procedure. The passage 80 may also facilitate the use of commercially available materials to replicate the lower esophagus to stomach anatomy. The esophagus extension bottom end 74 is designed to replicate the anatomical anatomy of the upper stomach and its connection to the lower esophagus.

Esophagogastric balloon insertion is the insertion of a balloon into the esophagus and gastric area of a patient as a means of tamponading bleeding. An esophagogastric balloon insertion may be practiced on the present invention. In this configuration, the gastric balloon of the esophagogastric balloon will sit in the conical shape of the esophagus extension bottom end 74. To add to the fidelity of the training, the esophagus model 100 may be removably inserted into to the head and neck model 12. The esophagus extension 70 may be connected to the esophagus extension attachment site 14 of the esophagus model 100 with the esophagus extension attachment 78 of the esophagus model 70. A tube (i.e., a Blakemore Tube) may be inserted in the mouth opening 18 of the esophagus model 100, continuing through the passage 80 of the esophagus model 100, through the esophagus extension attachment site 14 and the esophagus extension attachment 78 into the esophagus extension 70. The esophagus model 100 and the esophagus extension 70 may be used in conjunction with the head and neck model 12 or on a standalone basis. Practitioners may also attach commercially available materials to replicate the lower esophagus to stomach anatomy. With the simulator apparatus 10, practitioners may train in the procedure of placing an esophagogastric balloon, working on the mechanics of these complex devices.

The present invention has been described with reference to specific examples and configurations. It is only intended to be limited to the description set out in the claims and equivalents.

What is claimed is:

1. A head and neck anatomical simulator apparatus for training medical professionals in procedures involving the head and neck, the apparatus comprising a head and neck model substantially shaped like that of the human head and neck, having a base, one or more cylindrical cut outs, a rectangular cut out, a mouth cut out, and a throat opening.

2. The simulator apparatus of claim 1, wherein the apparatus has a cricothyroid model substantially shaped like that of the human cricothyroid cartilage, thyroid cartilage, and trachea having a cricothyroid top end, a cricothyroid bottom end, an airway, a thyroid protrusion, and a procedure site, wherein the cricothyroid model is removably attached to the rectangular cut out of the head and neck model.

3. The simulator apparatus of claim 1, wherein the apparatus has one or more eye models substantially shaped like that of the human eye and surrounding structures having an eyeball, an eye inset, and an eye base, wherein the one or more eye models are removably attached to one or more cylindrical cut outs of the head and neck model.

4. The simulator apparatus of claim 1, wherein the apparatus has an esophagus model substantially shaped like that of the human esophagus having a mouth opening, an esophagus, an esophagus extension top end, an esophagus extension bottom end, an esophagus extension base, an esophagus extension attachment, and an esophagus extension passage, wherein the esophagus model is removably attached to the mouth cut out of the head and neck model.

5. The simulator apparatus of claim 1, wherein the simulator apparatus is made of a nonmetallic material.

6. The simulator apparatus of claim 1, wherein the simulator apparatus comprising the head and neck model, the cricothyroid model, the eye model, and the esophagus model are made of one continuous structure.

7. The apparatus of claim 1, wherein each of the cricothyroid model, the eye model, and the esophagus model includes a plurality of pegs wherein the pegs are configured to be removably engaged with peg holes of the head and neck model.

8. A cricothyroid model apparatus to assist in training medical professionals in procedures involving the human cricothyroid muscle, thyroid, and trachea comprising;
a cricothyroid top end;
a cricothyroid bottom end;
an airway;
a thyroid protrusion:
a procedure site; and
a cricothyroid back side.

9. The cricothyroid model apparatus of claim 5, wherein the cricothyroid model is made of a nonmetallic material.

10. The cricothyroid model apparatus of claim 5, wherein the cricothyroid back side is configured to be removably engaged with a surface to secure the apparatus while in use.

11. An eye model apparatus to assist in training medical professionals in procedures involving the human eye comprising;
an eyeball;
an eye inset; and
an eye base.

12. The eye model apparatus of claim 8, wherein the eye model is made of a nonmetallic material.

13. The eye model apparatus of claim 8, wherein the eye base of the eye model apparatus is configured to be removably engaged with a surface to secure the apparatus while in use.

14. An esophagus model apparatus to assist in training medical professionals in procedures involving the human esophagus comprising;
an esophagus;
an esophagus extension top end;
an esophagus extension bottom end;
an esophagus extension base;
an esophagus extension attachment; and
a passage.

15. The esophagus model of claim 11, wherein the esophagus model is made of a nonmetallic material.

16. The esophagus model apparatus of claim 11, wherein the esophagus extension base is configured to be removably engaged with a surface to secure the apparatus while in use.
